(19) United States
(12) Patent Application Publication
(10) Pub. No.: US 2009/0193494 A1
(43) Pub. Date: Jul. 30, 2009

(54) MANAGING ACTIONS OF VIRTUAL ACTORS IN A VIRTUAL ENVIRONMENT

(75) Inventors: Emily Jane Ratliff, Austin, TX (US); Janani Janakiraman, Austin, TX (US)

Correspondence Address: IBM Corp. (GIG), c/o Garg Law Firm, PLLC, 4521 Copper Mountain Lane, Richardson, TX, 75082, US

(73) Assignee: International Business Machines Corporation, Armonk, TX (US)

(21) Appl. No.: 12/022,285

(22) Filed: Jan. 30, 2008

(51) Int. Cl. G06F 17/00

(52) U.S. Cl. 726/1

(57) ABSTRACT

A method, system, and computer usable program product for monitoring the actions of a virtual actor are provided in the illustrative embodiments. An interaction of the virtual actor acting in a role is detected. A set of policies is applied to the interaction. The set of policies include an auditing policy. Auditing according to the auditing policy is determined based on the role of the virtual actor.

### BACKGROUND OF THE INVENTION

1. Field of the Invention

The present invention relates generally to an improved data processing system, and in particular, to a computer implemented method for managing activities in data processing systems. Still more particularly, the present invention relates to a computer implemented method, system, and computer usable program code for managing actions of virtual actors in a virtual environment.

2. Description of the Related Art

An online environment is an environment created using data processing systems and software within which a user can perform functions that correspond to real world functions. Online environments incorporate aspects of the real world in order to provide a life-like experience to the users. For example, the graphics in online environments are becoming increasingly realistic, including three dimensional rendering of structures, places, and actors. Images of actors and devices in online environments also move with increasingly smooth motions that resemble the fluidity of motions in the real world. Computer games, such as those available for gaming consoles, are some examples of such online environments. Second Life® is another example of an online environment. Second Life is a registered trademark of Linden Research, Inc. in the United States and other countries.

Such an online environment is also commonly known as a virtual environment, a virtual world, or a virtual space. The modifier “virtual” prefixed to a noun informs the user that the user is operating in an online environment. For example, a virtual store is a store where the user can buy things, only that the store is in an online environment and not in a brick and mortar building. Similarly, a virtual world is an online environment in which virtual creatures move about and perform actions similar to how real creatures would in a comparable real world environment.

Actors operating in virtual environments use virtual tools to perform their functions. For example, a virtual shopper in a virtual store uses a virtual identity to perform a transaction. A virtual actor in a virtual world gaming environment uses virtual gadgets to perform the virtual actor's functions. A virtual identity is a set of attributes associated with an actor that identify the actor and enable the actor's functions in a virtual environment. An attribute is a property that can be assigned a value where the value determines a characteristic. An actor with a virtual identity is a virtual actor. Virtual actors are also known as “Avatar” in the pertinent art.

Generally, a virtual actor is associated with a real user. Consequently, the actions of a virtual actor in a virtual environment may have real world implications for the real user. For example, a virtual actor conducting a financial transaction in a virtual store may result in a real bill that the real user has to pay with real money to a real company that may be operating the virtual store.

### SUMMARY OF THE INVENTION

The illustrative embodiments provide a method, system, and computer usable program product for monitoring the actions of a virtual actor. An interaction of the virtual actor acting in a role is detected. A set of policies is applied to the interaction. The set of policies include an auditing policy. Auditing according to the auditing policy is determined based on the role of the virtual actor.

In monitoring the actions of the virtual actor, the set of policies also include one or more of a policy to authenticate the interaction, a policy to notify about the interaction, and a policy to log the interaction. Authenticating according to the policy to authenticate includes authenticating the virtual actor, the role of the virtual actor, or both.

In monitoring the actions of the virtual actor, the interaction is processed. The processing that is applied is determined based on the role of the virtual actor. The processing includes archiving, filtering, transcribing, translating the interaction, or any combination thereof. In one case, the processing is performed at the source of the interaction.

The auditing includes a pre-auditing function, a post-auditing function, or both. Authenticating can be the pre-auditing function.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of a user using a virtual actor in accordance with an illustrative embodiment;

FIG. 4 depicts a block diagram of associating a role with a virtual actor in accordance with an illustrative embodiment;

FIG. 5 depicts a pseudo code of an exemplary rule for the role selection in accordance with an illustrative embodiment;

FIG. 6 depicts a table of exemplary attributes associated with roles in accordance with an illustrative embodiment;

FIG. 7 depicts a block diagram of auditing a virtual actor's activities in accordance with an illustrative embodiment;

FIG. 8 depicts a block diagram of server applications for auditing virtual actor interactions in accordance with an illustrative embodiment;

FIG. 9 depicts a block diagram of exemplary server applications for processing virtual actor interactions in accordance with an illustrative embodiment;

FIG. 10 depicts a block diagram of processing a virtual actor communication in accordance with an illustrative embodiment;

FIG. 11 depicts a block diagram of a virtual actor acting in a role affecting a data processing environment in accordance with an illustrative embodiment;

FIG. 12 depicts a flowchart of a process for assigning a role to a virtual actor in accordance with an illustrative embodiment;

FIG. 13 depicts a flowchart of a process of applying policies to an interaction that is using a virtual actor in a role in accordance with an illustrative embodiment; and

FIG. 14 depicts a flowchart of a process of affecting a data processing environment in accordance with an illustrative embodiment.

### DETAILED DESCRIPTION OF THE PREFERRED EMBODIMENT

A set of attributes associated with a virtual actor form the virtual actor's virtual identity. A set of attributes is one or more attributes. A name, an address, an article of clothing, and a credit card number are some examples of the attributes that may be included in a virtual identity. A subset of the attributes may identify the virtual actor, and another subset of the attributes may enable the virtual actor to perform certain functions.

A user may be associated with a virtual actor such that the virtual actor may act on the user's behalf in a virtual environment. Illustrative embodiments recognize that the user may have to change certain attributes of the virtual identity of the virtual actor from time to time. For example, the user may assign one set of attributes to the virtual actor so that the virtual actor may accomplish certain functions. The user may then want to change the attribute to allow the virtual actor to accomplish a different set of functions.

Presently, the user has to create several virtual actors with varying attributes to accomplish different functions. Because the actions of those virtual actors may be attributable to the user, the user has the responsibility to keep track of several virtual actors with which the user may be associated. Tracking several virtual actors and their virtual identities can be time consuming and error prone, and can cause real-world problems for the user should the user fail to manage the actions of the several virtual actors.

The illustrative embodiments provide a method, system, and computer usable program code for managing the actions of virtual actors. The illustrative embodiments provide a method for assigning different roles to a common virtual actor. A role is a modifiable set of attributes that the user can apply to an existing virtual actor and change the behavior of the virtual actor. A role encompasses virtual identity and is more flexible and extensible than a virtual identity.

Changing the role of a virtual actor according to the illustrative embodiments modifies one or more attributes of the virtual actor. Changing the role of the virtual actor causes the same virtual actor to perform a set of functions or behave in a particular manner that is different from the functions or behavior under a previous role. A set of functions is one or more functions. For example, being able to conduct a transaction using a particular credit card may be a function of a virtual actor in one role, for example, a business role. By changing the roles of the virtual actor, for example, to a personal role, the virtual actor may not be able to perform the same transaction using that particular credit card. Being able to read a document, revise a document, or communicate with certain other virtual actors are some more examples of functions that a virtual actor may be able to perform in one role but not in another.

The illustrative embodiments further provide methods for auditing the actions of a virtual actor acting in a certain role. For example, a virtual actor may have a business role in which the virtual actor acts on behalf of an employee of a company. Because the actions of the virtual actor acting in that role may be attributable to a real employee of the company, the company may use the illustrative embodiments to apply company policies, monitor, or audit the virtual actor's communications.

The illustrative embodiments further provide methods for modifying a virtual actor's behavior or actions that may be acting in a particular role. For example, a company's auditing policy may prohibit the use of certain words in corporate communications. If a virtual actor acting in a business role uses a prohibited word in a corporate communication, an administrator or a system in the company may delete or modify that word from the virtual actor's corporate communication using the illustrative embodiments.

The illustrative embodiments further provide methods for modifying a virtual actor's behavior according to specific circumstances. For example, a virtual actor may communicate with other virtual actors using English as the default language. However, for communications with a specific other virtual actor, the illustrative embodiments may modify the behavior of the virtual actor such that the communication reaches the other virtual actor in a different language, such as in Mandarin or French.

The illustrative embodiments further provide methods for affecting certain aspects of an environment—virtual as well as real—because of the actions of a virtual actor acting in a certain role. For example, using the illustrative embodiments, an action of a virtual actor in a business role may debit a financial account belonging to the company. Acting in a personal role, an action of the virtual actor may debit a personal account of the user. An account may be a virtual account corresponding to a virtual environment, or a real bank account corresponding to a real environment.

As another example, acting in a business role, the virtual actor may not be able to access the security system of the user's home. However, acting in a personal role, the virtual actor may be able to access the security system, such as to turn on the lights of the user's home. The user's home in this example is a real environment.

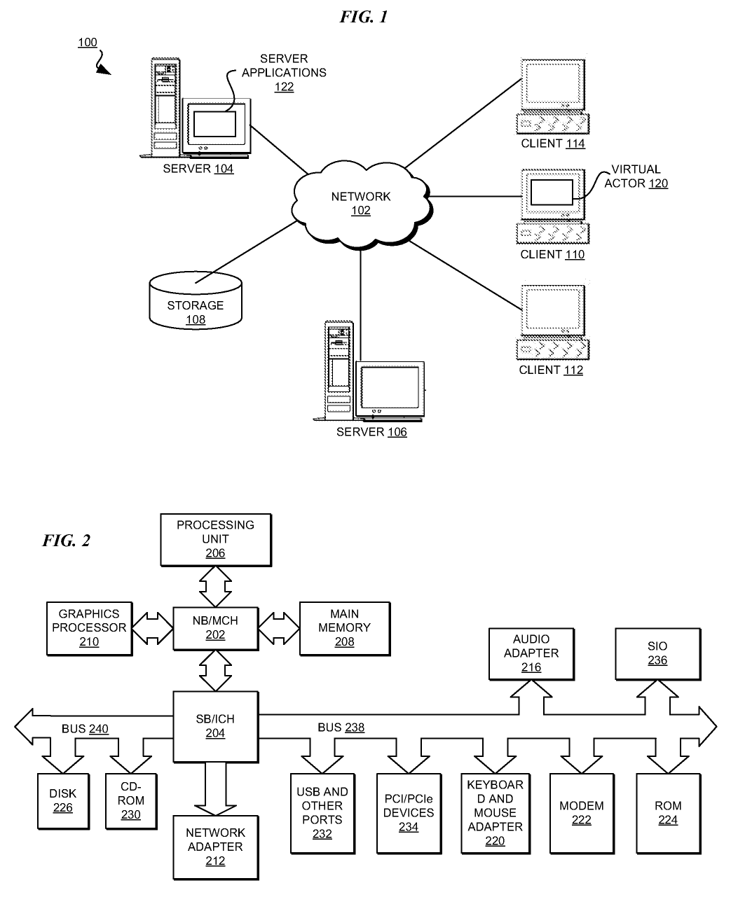

With reference to the figures and in particular with reference to FIGS. 1 and 2, these figures are exemplary diagrams of data processing environments in which illustrative embodiments may be implemented. FIGS. 1 and 2 are only exemplary and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Server 104 and server 106 couple to network 102 along with storage unit 108. In addition, clients 110, 112, and 114 couple to network 102. Servers 104 and 106, storage units 108, and clients 110, 112, and 114 may couple to network 102 using wired connections, wireless communication protocols, or other suitable data connectivity. Clients 110, 112, and 114 may be, for example, personal computers, mobile devices, or network computers.

In the depicted example, server 104 provides data, such as boot files, operating system images, and applications to clients 110, 112, and 114. Clients 110, 112, and 114 are clients to server 104 in this example. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. The Internet includes a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client server environment. A client server environment enables software applications and data to be distributed across a network such that an application functions by using the interactivity between a client data processing system and a server data processing system.

A user may access a virtual actor, such as virtual actor 120, from a client computer, such as client 110. The user may manipulate the roles assigned to virtual actor 120 using client 110. Virtual actor 120 may be a software application or a component thereof executing on client 110.

Software applications corresponding to virtual actor 120, such as server applications 122, may also execute on a server, such as on server 104. Server applications 122 may be one or more software applications. Server applications 122 may include functionality to create, control, manipulate, audit, or apply other policies to virtual actors and their activities for one or more users.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Linux® (Linux is the trademark of Linus Torvalds in the United States, other countries, or both). An object oriented programming system, such as the Java™ programming system, may run in conjunction with the operating system and provides calls to the operating system from Java™ programs or applications executing on data processing system 200.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory, such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

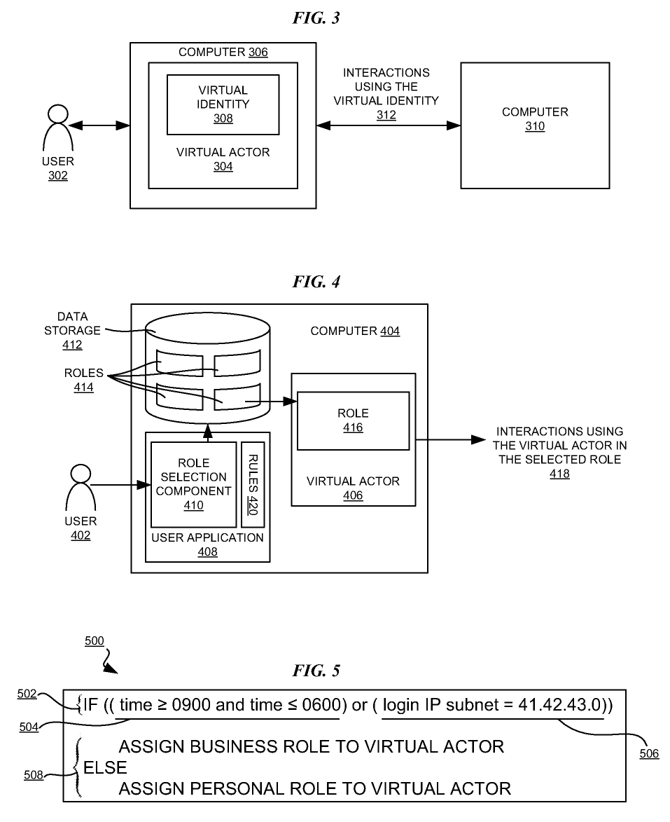

With reference to FIG. 3, this figure depicts a block diagram of a user using a virtual actor in accordance with an illustrative embodiment. User 302 may access virtual actor 304 using computer 306. Computer 306 may be a client computer, such as client 110 in FIG. 1. Virtual actor 304 may be analogous to virtual actor 120 in FIG. 1.

Virtual identity 308 may be associated with virtual actor 304 to identify virtual actor 304 in a virtual environment operating on computer 310. User 302 may use virtual actor 304 with virtual identity 308 for interactions 312 with the virtual environment on computer 310. An interaction is an exchange of information that may or may not include causing actions to occur at either of the interacting systems. An interaction includes communications, such as data, voice or text communication. An interaction using a virtual actor is an interaction in which a virtual actor is one of the entities involved in the interaction.

With reference to FIG. 4, this figure depicts a block diagram of associating a role with a virtual actor in accordance with an illustrative embodiment. User 402 may be the same as user 302 in FIG. 3. Computer 404 may be implemented using computer 306 in FIG. 3. Virtual actor 406 may be implemented using virtual actor 304 in FIG. 3, with additional features of the illustrative embodiments described below.

Computer 404 may include user application 408. User application 408 may further include role selection component 410. Computer 404 may also include data storage 412, which may store a number of roles 414. User 402, using role selection component 410 of user application 408, may select one of roles 414 from data storage 412 and assign to virtual actor 406. Virtual actor 406 then has role 416 that corresponds to the user-selected role from roles 414. Data storage 412 may be any form of data storage, such as a relational database, an object oriented database, a flat file, an index file, or any other suitable form of data storage.

The attributes included in role 416 may determine how virtual actor 406 behaves in interactions 418. User 402 may change role 416 of virtual actor 406 by using user application 408, selecting a different role from roles 414, and assigning the newly selected role as role 416 to virtual actor 406. Interactions 418 may be different for different role 416 of virtual actor 406.

User application 408 may include one or more rules, such as rules 420, to facilitate the role selection process. A rule in rules 420 is a logic that determines which role the user should select for assigning to virtual actor 406. A rule in rules 420 may be implemented in any manner suitable for use with user application 408, such as by coding the rule in a particular programming language. A particular implementation of the illustrative embodiments may store rules 420 in data storage 412 or another repository accessible over a data network.

A rules engine (not shown) associated with user application 408 may execute rules 420. A rule from rules 420 may be executed automatically to select and assign role 416 automatically without user intervention. Alternatively, executing a rule from rules 420 may use user intervention for selecting and assigning role 416.

With reference to FIG. 5, this figure depicts a pseudo code of an exemplary rule for the role selection in accordance with an illustrative embodiment. Rule 500 may be implemented as one of rules 420 in FIG. 4.

Rule 500 includes selection logic 502. Selection logic 502 may be any logic for selecting a role from two or more roles. Here, selection logic 502 includes two exemplary conditions that cause selection logic 502 to be true or false. First condition 504 determines if the time at which the user is logging in falls within a predetermined time window. For example, first condition 504 uses the time of a user logging in and becomes true if the user logs in between 9 AM and 6 PM. Thus, in this example, first condition 504 becomes true when the user is likely to be at work.

Similarly, second condition 506 uses the Internet protocol address (IP address) of the computer from which the user logs in. In this example, second condition 506 becomes true if the user logs in from a computer whose IP address is on the company's network that has a particular subnet mask, such as an exemplary subnet mask of 41.42.43.0. Thus, second condition 506 becomes true when the user is also likely at work.

In this example, if either of first condition 504 or second condition 506 becomes true, selection logic 502 becomes true. Rule 500 selects from two exemplary roles in body 508 based on whether selection logic 502 is true or false. If selection logic 502 is true, rule 500 selects an exemplary business role for the virtual actor corresponding to the user. If selection logic 502 is false, indicating in the example that the user is not at work, rule 500 selects an exemplary personal role.

Rule 500 is only exemplary and has been selected for the clarity of the description of the illustrative embodiments. A particular implementation may implement a rule with any number of conditions, with a selection logic of any complexity, and a selection of role from any number of roles without departing from the scope of the illustrative embodiments.

Furthermore, an implementation of rule 500 may include the functionality for not only selecting a role but also assigning the selected role to a virtual actor. The implementation may further include other functions, code, and logic that may be suitable for a particular implementation.

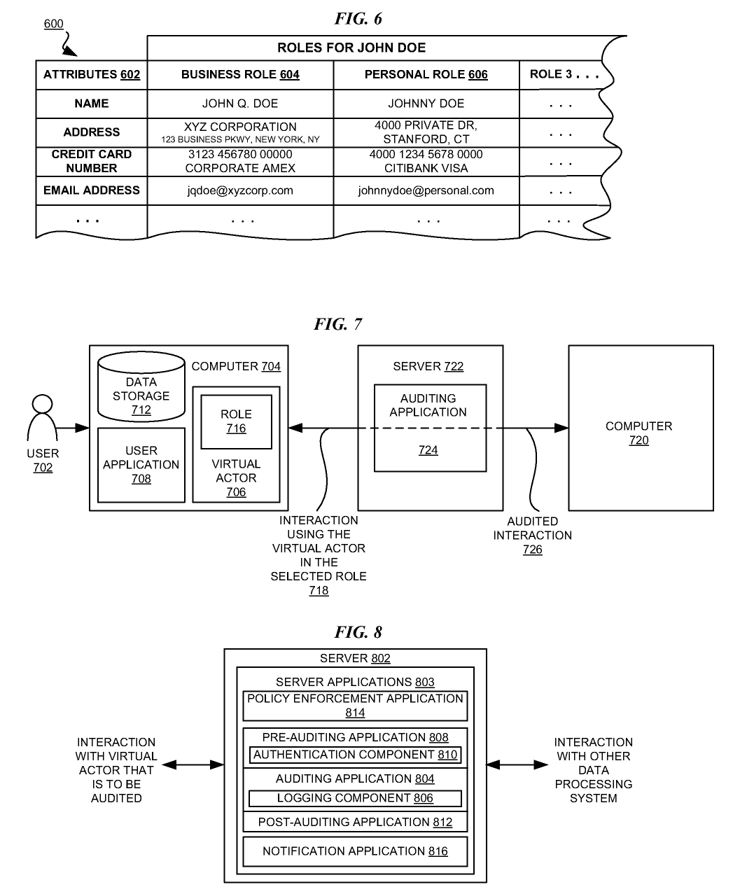

With reference to FIG. 6, this figure depicts a table of exemplary attributes associated with roles in accordance with an illustrative embodiment. Table 600 may be one or more tables or data structures, may include the attributes for one or more roles, and may be implemented as roles 414 in FIG. 4.

Table 600 depicts attributes 602 for two exemplary roles of a virtual actor associated with an exemplary user John Doe. For this user, table 600 includes business role 604 and personal role 606.

Attributes 602 may include any number or types of attributes suitable for a particular virtual actor. Here, attributes 602 exemplarily include a name attribute, an address attribute, a credit card number attribute, and an email address attribute. For example, the name attribute for business role 604 has the value “John Q. Doe”, whereas the same attribute for personal role 606 has the value “Johnny Doe”. The different values for the name attribute in the two roles show that the virtual actor associated with user John Doe uses a formal name when business role 604 is assigned, and a nickname when personal role 606 is assigned to the virtual actor.

Similarly, in this example, the address attribute stores the address of the business where user John Doe works when the virtual actor is assigned business role 604. The address attribute stores John Doe's home address for personal role 606. The credit card attribute similarly stores different credit card numbers for business role 604 and personal role 606. Email addresses stored in the email address attribute for John Doe's virtual actor are also different in the two roles.

In the above example, each attribute stores different values for each role. However, an implementation may store same or different values for an attribute for some or all roles that may be assignable to a virtual actor. A role may use only some of the available attributes, and not use the other available attributes.

Additionally, any number of roles may be stored in table 600 and may be assigned to a virtual actor associated with a user. A role may also be common to more than one user and virtual actor. For example, attributes 602 may include only the address attribute and a company phone number attribute. In such a case, those two attributes are likely to have identical values in business roles of the virtual actors associated with a group of employees of the company. An implementation may create a common business role for the virtual actors associated with that group of employees, and assign that business role when an employee in that group uses a virtual actor for business. Many other variations of attributes and roles will be apparent from this disclosure and are contemplated within the scope of the illustrative embodiments.

With reference to FIG. 7, this figure depicts a block diagram of auditing a virtual actor's activities in accordance with an illustrative embodiment. User 702 may be the same as user 402 in FIG. 4. Computer 704 may be implemented using computer 404 in FIG. 4. Virtual actor 706 may be analogous to virtual actor 406, user application 708 may be analogous to user application 408 including components therein, data storage 712 may be analogous to data storage 412, and role 716 may be analogous to role 416 in FIG. 4.

Interaction 718 may be an interaction that uses virtual actor 706 in role 716. Interaction 718 may be analogous to interaction 418 in FIG. 4. Interaction 718 may be targeted to computer 720, or a virtual environment facilitated by computer 720.

In accordance with the illustrative embodiment, interaction 718 may pass through other data processing systems before reaching computer 720. Server 722 is an exemplary data processing system that intervenes transaction 718 between computer 704 and computer 720. Server 722 may be implemented using server 104 in FIG. 1.

As an example, computer 704 may be a data processing system on a local area network (LAN) within a company's corporate intranet. Computer 720 may be a data processing system situated in a network that belongs to one of the company's clients. Server 722 may be coupled to the company's LAN and audit the interactions that involve computers within the corporate intranet.

Server 722 includes auditing application 724. Auditing application 724 may be one of server applications 122 in FIG. 1. Auditing application 724 may audit virtual actor communications. A virtual actor communication is a communication in which a virtual actor is one of the communicating entities. Virtual actor communications include textual communications, data communications, voice communications, transactions, such as financial or electronic data interchange (EDI) transactions, and any other interactions that may originate from, terminate at, or otherwise involve a virtual actor. Auditing application 724 audits transaction 718 that exemplarily originates from virtual actor 706 in this illustrative embodiment. Server 722 then sends audited interaction 726 to computer 720 to complete the interaction that started as interaction 718.

Auditing a communication is performing an audit function or operation on a virtual actor communication. In addition to auditing, pre-auditing and post-auditing functions may also be performed on a communication. For example, for auditing a communication, a company may first authenticate or otherwise validate a virtual actor before allowing that virtual actor to communicate outside the corporate data network.

In addition to auditing, a number of policies can be applied to a virtual actor communication. For example, a company may apply corporate communication policies to the virtual actor communications. Policies may include prohibiting certain words in corporate communications, and prohibiting communication with certain virtual actors, computers, websites, entities, groups, or organizations outside the company. Policies may also include limiting the duration of a communication, permitting certain communications at certain times and days, adding other users or virtual actors to particular communications, delaying a particular communication, and many other decisions and actions that may be possible with respect to a communication. Auditing a virtual actor communication may itself be an application of a policy, such as an auditing policy.

With reference to FIG. 8, this figure depicts a block diagram of server applications for auditing virtual actor interactions in accordance with an illustrative embodiment. Server 802 may be implemented using server 722 in FIG. 7. Server applications 803 may be analogous to server applications 122 in FIG. 1. Auditing application 804 may be analogous to auditing application 724 in FIG. 7.

Auditing application 804 may include any number of components for performing various auditing functions that may be suitable for a particular implementation. In the exemplary embodiment of FIG. 8, auditing application 804 includes logging component 806. Logging component 806 may log all or part of a virtual actor communication. Pre-auditing application 808 may perform pre-auditing functions. For example, authentication component 810 may authenticate a virtual actor, a role, an interaction, or a combination thereof before an auditing process begins. Pre-auditing application 808 and authentication component 810 may be parts of a security infrastructure in a particular implementation.

Post-auditing application 812 may perform functions following an auditing process. For example, post-auditing application 812 may compress, encrypt, or save at a remote location a log file that may be generated during an audit.

Policy enforcement application 814 may describe and implement policies that an implementation may impose on virtual actor communications. Notification application 816 may notify persons or systems about all or part of a virtual actor communication, such as by email, page, by displaying a popup on a system administrator's computer.

In one embodiment, the depicted applications and components, and other similar applications and components may operate as components of policy enforcement application 814. In another embodiment, the depicted applications and components and other similar applications and components may execute as separate applications. The applications may further include other or different components in particular implementations. Additionally, server 802 may execute the various components as separate application without departing from the scope of the illustrative embodiments.

Furthermore, a component or an application may use rules to determine when and whether a particular function is to be triggered. For example, notification application 810 may notify a system administrator if a virtual actor is establishing a communication with an unauthorized entity outside the company. The logic for “if a virtual actor is establishing a communication with an unauthorized entity” may be encapsulated in the form of a rule that notification application 810 may use in making the above determination. Many other rules are conceivable from this disclosure.

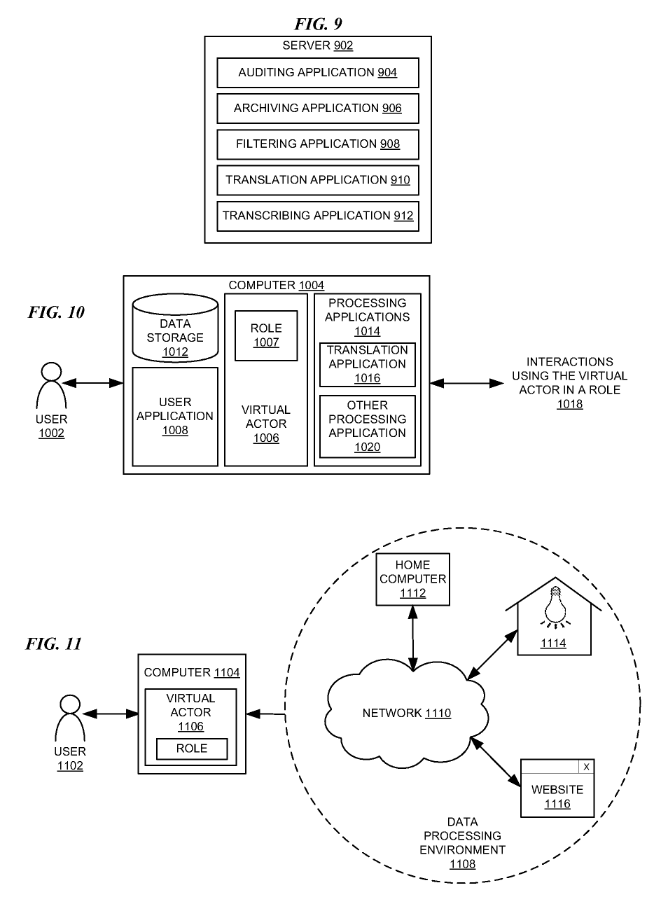

With reference to FIG. 9, this figure depicts a block diagram of exemplary server applications for processing virtual actor interactions in accordance with an illustrative embodiment. Server 902 may be implemented using server 802 in FIG. 8. Auditing application 904 may be analogous to auditing application 804 in FIG. 8.

Server 902 may include many other applications besides auditing application 904 for processing virtual actor communications. These applications are called processing applications. Processing applications on a server are called server-side processing applications. The processing applied by the processing applications may be independent from or a part of the auditing process. For example, archiving may be a part of a particular implementation of the auditing process. Consequently, server 902 may include archiving application 906 in addition to auditing application 904.

Similarly, filtering application 908 may filter out unauthorized or undesirable parts of a virtual actor communication, and pass through the remaining portion of the communication. Translation application 910 may translate all or part of a virtual actor communication, for example, from English to Japanese. Transcribing application 912 may transcribe all or part of a virtual actor communication, for example, by replacing a text with a symbol in the communication, or vice versa.

Any of the depicted applications or other similar applications on server 902 may use rules in the manner described above with respect to FIG. 8. Furthermore, additional or different applications may execute on server 902 depending on particular implementation of the illustrative embodiments.

Furthermore, server 902 may include more than one data processing systems that are in communication with each other over a data network. The various applications and the various components thereof may execute on separate data processing systems without departing from the scope of the illustrative embodiments.

With reference to FIG. 10, this figure depicts a block diagram of processing a virtual actor communication in accordance with an illustrative embodiment. User 1002 may be user 402 in FIG. 4. Computer 1004 may be implemented using computer 404 in FIG. 4. Virtual actor 1006 acting in role 1007 may be analogous to virtual actor 406, user application 1008 may be analogous to user application 408, and data storage 1012 may be analogous to data storage 412 in FIG. 4.

In one embodiment, as in FIG. 9, processing applications may execute on a server that may be separate from the computer on which a user accesses a virtual actor. In another embodiment, as in FIG. 10, processing applications may execute on the computer that the user uses to access the virtual actor. These processing applications are called client-side processing applications. In another embodiment, some of the processing applications may be server-side processing applications and others may be client-side processing applications.

Processing applications 1014 may include client-side processing applications. For example, translation application 1016 may be a client-side processing application that translates virtual actor 1006's communications, such as from English to Japanese, when virtual actor 1006 is acting in role 1007. By performing the translation on computer 1004, translation application 1016 may cause interaction 1018 to be in Japanese when the communication reaches a server on the intranet, such as server 902 in FIG. 9. In some cases, eliminating server-side processing may result in overall improved efficiency of the entire virtual actor communication process.

Other processing application 1020 may be any other processing application, such as for logging, archiving, or other auditing functions as described above. As an example, other processing application 1020 may be an encryption application that may encrypt a virtual actor communication using an encryption algorithm.

The processing applications described here are only exemplary and not intended to be limiting on the illustrative embodiments. Many other processing applications will be conceivable from this disclosure and are within the scope of the illustrative embodiments.

With reference to FIG. 11, this figure depicts a block diagram of a virtual actor acting in a role and affecting a data processing environment in accordance with an illustrative embodiment. User 1102 may be user 1002 in FIG. 10. Computer 1104 may be implemented using computer 1004 in FIG. 10. Virtual actor 1106 and other components (not shown) may be analogous to virtual actor 1006 and other corresponding components in FIG. 10.

User 1102 may assign role 1107 to virtual actor 1106 as described above. In role 1107, virtual actor 1106 may manipulate data and devices that are accessible to virtual actor 1106 in that role. For example, when role 1107 is a personal role, virtual actor 1106 may access data processing environment 1108 that may exist in user 1102's home. Network 1110 may be a LAN in data processing environment 1108 to which virtual actor 1106 in personal role may have access.

Acting in the personal role, virtual actor 1106 may be able to access user 1102's home computer 1112 or lighting system 1114. Virtual actor 1102 may also be able to gain access to certain websites to which user 1102 has access from home. For example, if a website recognizes the IP address of a computer on network 1110 from which user 1102 accesses the website, virtual actor 1106 may gain access to that website by having access to network 1110 in the personal role.

Thus, user 1102 may assign role 1107 to virtual actor 1106 to perform functions, manipulate data or devices, or generally affect data processing environment 1108. Of course, data processing environment 1108 may be any data processing environment, such as a shipper's warehouse, a corporate intranet, or a manufacturing plant's system. Depending on the nature of the particular data processing environment being affected, user 1102 may assign appropriate role 1107 to virtual actor 1106 and affect changes in the data processing environment.

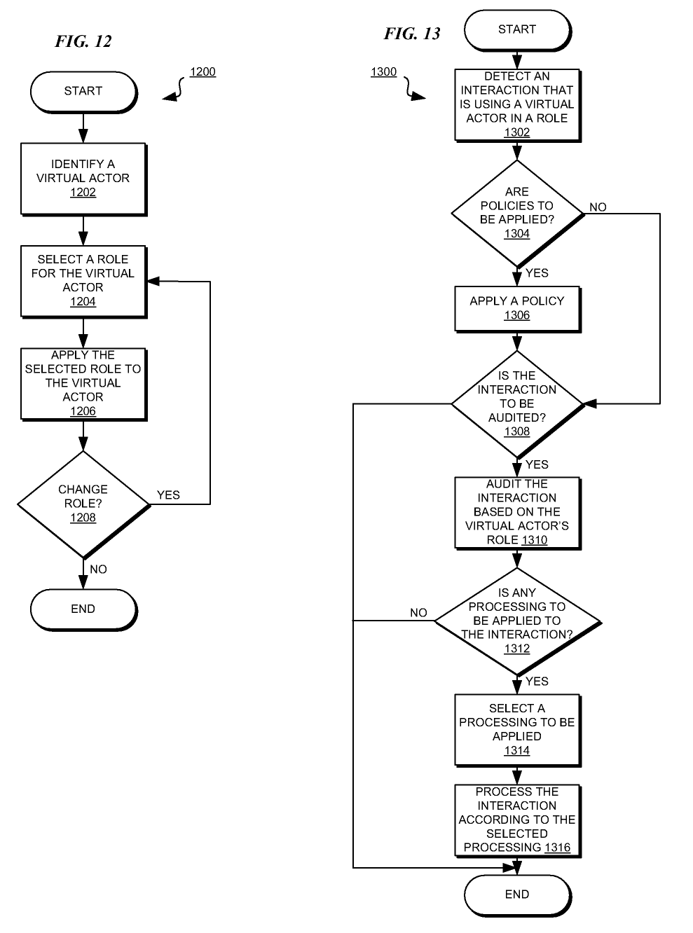

With reference to FIG. 12, this figure depicts a flowchart of a process for assigning a role to a virtual actor in accordance with an illustrative embodiment. Process 1200 may be implemented in user application 408, such as in role selection component 410 in FIG. 4.

Process 1200 begins by identifying a virtual actor (step 1202). The process selects a role for the identified virtual actor (step 1204). The process applies the selected role to the virtual actor (step 1206).

The process determines if the role assigned to the virtual actor in step 1206 has to be changed (step 1208). If the process determines that the role of the virtual actor has to be changed (“Yes” path of step 1208), the process returns to step 1204. If the process determines that the role assigned in step 1206 is not to be changed (“No” path of step 1208), the process ends thereafter.

With reference to FIG. 13, this figure depicts a flowchart of a process of applying policies to an interaction that is using a virtual actor in a role in accordance with an illustrative embodiment. Process 1300 may be implemented in a policy enforcement application, such as policy enforcement application 814 in FIG. 8.

Process 1300 begins by detecting an interaction that may be using a virtual actor in a particular role (step 1302). The process determines if any policies are to be applied to the interaction (step 1304). If one or more policies are to be applied (“Yes” path of step 1304), the process selects and applies a policy (step 1306). The process proceeds to step 1308. If no policies are to be applied (“No” path of step 1304), the process also proceeds to step 1308.

In one embodiment, the process may return to step 1304 (not shown) to determine if more policies are to be applied. In that embodiment, the process may repeat steps 1304 and 1306 for each policy that is to be applied before proceeding to step 1308.

The process determines if the interaction is to be audited (step 1308). If the process determines that the interaction is not to be audited (“No” path of step 1308), the process terminates thereafter.

If, however, the process determines that the interaction is to be audited (“Yes” path of step 1308), the process audits the interaction based on the virtual actor's role (step 1310). The process then determines if any processing is to be applied to the interaction (step 1312). If the process determines that no processing is to be applied to the interaction, the process terminates thereafter.

If, however, the process determines that some processing, such as archiving, translation, or transcribing, is to be applied to the interaction (“Yes” path of step 1312), the process selects the processing to be applied (step 1314). The process processes the interaction using the processing selected in step 1314 (step 1316). The process ends thereafter.

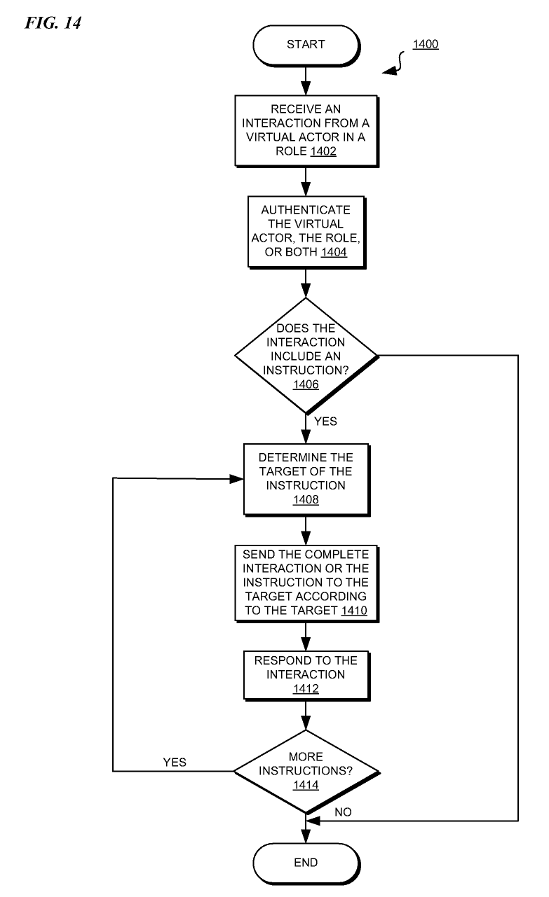

With reference to FIG. 14, this figure depicts a flowchart of a process of affecting a data processing environment in accordance with an illustrative embodiment. Process 1400 may be implemented in a data processing environment, such as data processing environment 1108 in FIG. 11.

The process begins by receiving an interaction from a virtual actor acting in a particular role (step 1402). The process may authenticate the virtual actor, the role in which the virtual actor may be acting, or both (step 1404). A particular implementation of process 1400 may omit step 1402.

The process determines if the interaction includes an instruction, such as an instruction to perform an action in the data processing environment (step 1406). An instruction may be a code, software function call, verbal command, a coded message, or any other form of communication that instructs the receiver of the instruction to perform a certain action.

If the process determines that the interaction does not include an instruction (“No” path of step 1406), the process ends thereafter. If, however, the process determines that the interaction includes an instruction (“Yes” path of step 1406), the process determines a target of the instruction (step 1408). For example, the instruction may be directed to a particular computer in a network, or to a particular device, such as a security console, in a user's home. The computer in the network, or the security console are examples of a target.

The process directs the complete interaction or just the instruction to the target based on the particular interaction, instruction, or implementation (step 1410). In one embodiment, the process may direct the entire interaction from the virtual actor to the target. In another embodiment, the process may separate the instruction from the interaction and direct only the instruction to the target.

In another embodiment, the interaction may include multiple instructions. In such cases, the process many direct a combination of a portion of the interaction and some instructions to one target, and another portion of the interaction with some other instructions to another target. A particular implementation may direct the interaction and instructions to targets in any manner without departing from the scope of the illustrative embodiments.

The process may respond to the interaction received in step 1402 (step 1412). A particular implementation of the illustrative embodiment may omit step 1412.

The process determines if more instructions are present in the interaction (step 1414). If more instructions are present (“Yes” path of step 1414), the process returns to step 1408. If the process determines that no more instructions are present (“No” path of step 1414), the process ends thereafter.

The components and applications in the block diagrams and the steps in the flowcharts described above are described only as exemplary. The components, the applications, and the steps have been selected for the clarity of the description and are not limiting on the illustrative embodiments. For example, a particular implementation may combine, omit, further subdivide, modify, augment, reduce, or implement alternatively, any of the components or steps without departing from the scope of the illustrative embodiments. Furthermore, the steps of the processes described above may be performed in a different order within the scope of the illustrative embodiments.

Thus, a computer implemented method, apparatus, and computer program product are provided in the illustrative embodiments for monitoring actions of virtual actors in a virtual environment. By implementing the illustrative embodiments, a user may be able to assign a role selected from several roles to a virtual actor. The user may be able to switch roles of a virtual actor to enable the virtual actor to behave differently in the different roles.

The roles of a virtual actor may be automatically assigned by determining certain factors, such as time and place of the user's login. The user may be able to override a selected role and assign a different role to the virtual actor.

A user may be able to monitor the actions of a virtual actor using the illustrative embodiments. For example, the user may enforce policies on the virtual actor interactions. The user may audit the interactions that use a virtual actor in a particular role. The user may also modify the interactions while monitoring or auditing the interactions. The user may modify the interactions by applying processing to the interactions using server-side processing applications, client-side processing applications, or both.

A user, using a virtual actor in a particular role, may affect changes in a data processing environment. The interactions from the virtual actor in a role may cause actions in the data processing environment, or changes in the data or states of one or more devices in the data processing environment.

The invention can take the form of an entirely hardware embodiment, an entirely software embodiment, or an embodiment containing both hardware and software elements. In a preferred embodiment, the invention is implemented in software, which includes but is not limited to firmware, resident software, and microcode.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for monitoring an action of a virtual actor, the method comprising:
detecting an interaction of the virtual actor acting in a role; and
applying a set of policies to the interaction, the set of policies including an auditing policy, wherein an auditing according to the auditing policy is determined based on the role of the virtual actor.

2. The method of claim 1, wherein the set of policies further includes a policy to at least one of authenticate the interaction, notify about the interaction, and log the interaction.

3. The method of claim 2, wherein authenticating according to the policy to authenticate includes at least one of authenticating the virtual actor and the role of the virtual actor.

4. The method of claim 1, further comprising:
processing the interaction, the processing being determined based on the role of the virtual actor.

5. The method of claim 4, wherein the processing includes one of archiving, filtering, transcribing, and translating the interaction.

6. The method of claim 4, wherein the processing is performed at the source of the interaction.

7. The method of claim 1, wherein the auditing includes at least one of a pre-auditing function and a post-auditing function.

8. The method of claim 7, wherein the pre-auditing function is authenticating.

9. A method for switching roles of a virtual actor, the method comprising:
identifying the virtual actor;
selecting a first role for the virtual actor;
applying the first role to the virtual actor;
selecting a second role; and
applying the second role to the virtual actor, wherein applying the second role to the virtual actor changes a function that the virtual actor can perform.

10. The method of claim 9, wherein a user is associated with the virtual actor, wherein the first role is selected from a plurality of roles, and wherein each role in the plurality of roles determines a set of functions that the virtual actor is able to perform when assigned that role.

11. The method of claim 9, wherein the selecting the first role occurs based on determining at least one of a time of login, and an identifier associated with a device used of login.

12. The method of claim 9, wherein a user performs one of accepts the first role and overrides the first role by replacing the first role with a third role.

13. A method for manipulating a data processing environment, the method comprising:
receiving an interaction from a virtual actor acting in a role;
identifying an instruction in the interaction;
determining a target for the instruction in the data processing environment; and
sending the instruction to the target.

14. The method of claim 13, further comprising:
authenticating one of the virtual actor, the role, and the virtual actor and the role, wherein the authenticating determines whether the virtual actor acting in the role is authorized to send the instruction.

15. The method of claim 13, wherein the interaction includes a plurality of instructions directed to a plurality of targets.

16. The method of claim 13, wherein sending the instruction includes sending one of the interaction, the instruction, and a combination of the instruction and the interaction to the target.

17. A computer usable program product comprising a computer usable medium including computer usable code for monitoring an action of a virtual actor, the computer usable code comprising:
computer usable code for detecting an interaction of the virtual actor acting in a role; and
computer usable code for applying a set of policies to the interaction, the set of policies including an auditing policy, wherein an auditing according to the auditing policy is determined based on the role of the virtual actor.

18. The computer usable program product of claim 17, wherein the set of policies further includes a policy to at least one of authenticate the interaction, notify about the interaction, and log the interaction.

19. The computer usable program product of claim 18, wherein authenticating according to the policy to authenticate includes at least one of authenticating the virtual actor and the role of the virtual actor.

20. The computer usable program product of claim 17, further comprising:
computer usable code for processing the interaction, the processing being determined based on the role of the virtual actor.

21. The computer usable program product of claim 20, wherein the processing includes one of archiving, filtering, transcribing, and translating the interaction.

22. The computer usable program product of claim 17, wherein the auditing includes at least one of a pre-auditing function and a post-auditing function.

23. A data processing system for manipulating a data processing environment, the data processing system comprising:
a storage device, wherein the storage device stores computer usable program code; and
a processor, wherein the processor executes the computer usable program code, and wherein the computer usable program code comprises:
computer usable code for receiving an interaction from a virtual actor acting in a role;
computer usable code for identifying an instruction in the interaction;
computer usable code for determining a target for the instruction in the data processing environment; and
computer usable code for sending the instruction to the target.

24. The data processing system of claim 23, further comprising:
computer usable code for authenticating one of the virtual actor, the role, and the virtual actor and the role, wherein the authenticating determines whether the virtual actor acting in the role is authorized to send the instruction.

25. The data processing system of claim 23, wherein the interaction includes a plurality of instructions directed to a plurality of targets, and wherein the computer usable code for sending the instruction includes computer usable code for sending one of the interaction, the instruction, and a combination of the instruction and the interaction to the target.
